(19) United States
(12) Patent Application Publication
(10) Pub. No.: US 2015/0368436 A1
(43) Pub. Date: Dec. 24, 2015

(54) High Carbon Grade Graphite Block And A Method To Make It

(71) Applicants: Gordon Chiu, Summit, NJ (US); Teresa Sung, Summit, NJ (US); Jay Walter McCloskey, Butte, MT (US); Robert John Hyatt, JR., Butte, MT (US)

(72) Inventors: Gordon Chiu, Summit, NJ (US); Teresa Sung, Summit, NJ (US); Jay Walter McCloskey, Butte, MT (US); Robert John Hyatt, JR., Butte, MT (US)

(21) Appl. No.: 14/307,583

(22) Filed: Jun. 18, 2014

(51) Int. Cl. C08K 7/14; H01B 1/04; C10M 125/02; C10M 129/00; C01B 31/04; C10M 125/26; C08K 3/04; C08K 3/18; C08K 5/04; C08K 7/10; G21F 1/08; C10M 125/28

(52) U.S. Cl. CPC C08K 7/14; G21F 1/08; H01B 1/04; C10M 125/02; C10M 129/00; C10M 125/28; C10M 125/26; C08K 3/04; C08K 3/18; C08K 5/04; C08K 7/10; C01B 31/04; C01B 2204/00

(57) ABSTRACT

A method to make a graphite block of any desired size and with over 99% carbon purity and high density is provided. The graphite block is obtained by mixing graphite flakes of any size with graphene oxide sheets and subjecting the mixture to elevated temperature and pressure. With this method large graphite blocks can be obtained economically and fast. The graphite blocks of this invention have superlubricity characters.

### PRIORITY

This application does not claim priority of any other application.

### FIELD OF THE INVENTION

The present invention relates to graphite blocks of high carbon purity having any chosen dimensions and a method to make same. The blocks have utility for example as thick lubrication blocks, low cost electrode replacements for expensive synthetic graphite electrodes, neutron ray filters, furnace liners in addition to other uses.

### BACKGROUND OF THE INVENTION

Graphite is a natural form of carbon. It holds an important role as industrial materials because of its outstanding heat and chemical resistances, high electric conductivity. It has been widely used as electrodes, heating elements, and structural materials. Due to its spectral and reflective characteristics it has also been used as X-ray or neutron ray monochromators, filters or spectral crystal articles.

Natural graphite may be used for all the aforementioned and other purposes. However, natural graphite with high quality occurs in an extremely limited amount and may be unsuitable for desired use due to its powder or flake form.

There are three principal types of natural graphite, each occurring in different types of ore deposit.

Crystalline flake graphite, also called flake graphite, occurs as isolated, flat, plate like particles with hexagonal edges if unbroken and when broken the edges can be irregular or angular. Most economic deposits of flake graphite are of the Archean to late Proterozoic age. These rocks may contain up to 90% graphite, although 10-15% graphite is a more typical ore body grade. Graphite flake ranges in size from 1 to 25 mm, with an average size of 2.5 mm. Commercially flake graphite is divided into coarse (150-850 μm in diameter) and fine (45-150 μm in diameter) flake. Fine flake may be further subdivided into medium flake (100 to 150 μm), fine flake (75 to 100 μm) and powder (less than 75 μm). Impurities include minerals commonly found in metasegments, such as quartz, mica, or calcite.

Amorphous graphite occurs as fine particles and is the result of thermal metamorphism of coal and is sometimes called meta-anthracite. Amorphous graphite is define as being finer than 40 μm in diameter, but some trade statistics define the upper limit at 70 μm. Deposits with grades over 80% carbon are considered to be economically viable.

Lump graphite which is also called vein graphite occurs in fissure veins or fractures and is probably hydrothermal in origin. Vein graphite is the rarest and most valuable form of graphite due to its high carbon grade. Vein graphite may come in lumps ranging from about 8 cm by diameter to as small as 5 μm. The purity of the vein graphite is usually between 94 and 99%.

The application of graphitic material is constantly evolving due to its unique chemical, electrical and thermal properties. Graphite maintains its stability and strength under temperatures in excess of 3500° C. and is very resistant to chemical corrosion. It is also one of the lightest of all reinforcing elements and has high natural lubricating abilities.

Natural graphite has varying levels of quality depending on the type. The degree of the purity can vary greatly and the purity is the factor that influences the use of the material in applications and the pricing of the material. Carbon purity of natural graphite ranges generally between 70 and 99%, as discussed above. High carbon purity is an important feature for high-tech applications of graphite, such as semiconductors, photovoltaic, and nuclear applications among other.

However, natural graphite with high quality occurs in an extremely limited amounts as discussed above. Usually graphite with very high carbon content (96-99%) has been achieved by chemical and thermal treatment to reduce the level of impurities. Therefore, efforts of producing synthetic graphite having similar characteristics as natural graphite have been made.

One of the processes of making synthetic graphite is one which includes pyrogenic deposition of hydrocarbons in vapor phase and hot working of gaseous hydrocarbons. In the process, re-annealing is effected at a temperature of 3400° C. for a long period of time under high pressure. The graphite thus obtained is called highly oriented pyrographite (HOPG) and although it has almost the same characteristics as natural graphite it does not have the lubricating character of natural graphene. Additionally, the process is long, complicated and the yield is low. Therefore the productions costs are high.

Synthetic graphite may be a manufactured product made by high temperature treatment of calcined petroleum coke and coal tar pitch. The manufacturing process includes various mixings, molding and baking operations followed the heat treatment at 2500 to 3000° C. The morphology of most synthetic graphite varies from flakey in fine powders to irregular grains and needles in coarser products. Due to the high temperature treatment volatile impurities are vaporized and the purity of the synthetic graphite is usually more than 99% carbon. Synthetic graphite is generally available in particle sized from about 2 micrometer powders to about 2 cm pieces.

Synthetic graphite producers are faced with escalating energy costs associated with turning petroleum coke into graphite. Petroleum coke is the solid waste remaining after refining oil. To turn petroleum coke into graphite is extremely energy intensive and therefore expensive, but additionally there is are environmental issues. Moreover, the supply of petroleum coke derived from low sulfur, sweet crude oil is diminishing.

One solution to the problem of natural graphite being impure and synthetic graphite being expensive is to chemically purify natural graphite to achieve natural graphite with higher purity. The commonly used chemical purification methods are hydrofluoric acid leaching and hydrochloric acid caustic leach. A high temperature thermal treatment also allows for purification of natural graphite. However, these purification methods still do not give carbon purity as high as synthetic carbon and therefore other methods to provide high purity graphite are needed.

For various purposes, there is also a need for graphite blocks and rods. Due to graphite's high thermal conductivity graphite blocks are preferred for example as furnace linings. Graphite blocks are also widely used for lubrication purposes. Graphite blocks are commonly made of synthetic graphite made of petroleum coke. However, because the price of synthetic graphite is high it is not economical to make graphite blocks from synthetic graphite. Therefore, other methods for producing graphite blocks are disclosed in the following patent publications:

U.S. Pat. No. 4,983,244 and EP 0360217 provide a method to produce graphite blocks by process where one or more polymer films selected form aromatic polyimides, aromatic polyamines and polyoxadiazoles are heat treated to obtain carbonaceous films. A plurality of the carbonaceous films are then hot pressured to obtain a thick graphite block.

U.S. Pat. No. 5,449,507 provides a process for producing a graphite block from a plurality of graphitizable polymer films or a plurality of carbonaceous films separately obtained from graphitizable polymer films. The method comprises superposing the polymer films or the carbonaceous films, and thermally treating the films in a substantially compression pressure-free condition. The graphite blocks obtained are about 1 cm thick and about 16 cm in square.

U.S. Pat. No. 7,491,421 provides a method to make a heat sink by grinding a composition formed nanometer natural graphite and bonding agent to a ball-like graphite and treating the ball-like graphite with high pressure, dipping it in liquid phase asphalt, graphitizing the mass to a dry graphite block and coating the block with metal to form the sink.

U.S. Pat. No. 5,236,468 provides a method for producing formed bodies from carbonaceous substances in which the starting materials are dry synthetic graphite particles and coal tar pitch particles. A mixture of the particles is compressed under pressure and the result is a compact carbonaceous body having a volume at least equal to that of a sphere of ⅛ inches in diameter.

Despite the efforts taken to develop synthetic large sized graphite blocks, synthetic graphite lacks some features of natural graphite. Purified natural flake graphite exhibits a much higher crystalline structure than synthetic and is therefore more electrically and thermally conductive. Furthermore, natural graphite has superior lubricating features. There is currently no existing procedure to make large blocks from natural flake graphite, although flake graphite can be used to make graphite foil. If the foil is 100% graphite, the stress/strain is insignificant and it fails to build a block.

Therefore, there is a need to provide a high purity graphite with the properties of natural graphite. There is also a need to provide a method to make large graphite blocks having a high carbon purity and lubricating characters.

The invention disclosed herein provides solutions to the flaws of the prior art.

### SUMMARY OF THE INVENTION

This invention generally provides a novel composition comprising graphite flakes and graphene oxide. In one aspect the composition comprises 1-10% of graphene oxide and 90-99% of graphite flakes. In one aspect of the invention the carbon grade of the composition embodiment is over 90% and in another aspect the carbon grade is 99%.

In one aspect this invention a graphite block composed of graphite flakes and graphene oxide is provided. A graphite block composed of graphite flakes and graphene oxide. The carbon grade of the block is preferably over 90% and more preferably the carbon grade is 99%.

In one aspect of the invention the graphite block has a volume of at least 1 cm³.

In one aspect of the invention the graphite block has a density of at least 1.8 g/cm³, preferably at least 1.9 g/cm³ and most preferably at least 2.0 g/cm³.

In one aspect of the invention the graphite block may contain enforcing fibers.

In one aspect of the invention a process to make a graphite block from graphite flakes and graphene oxide, wherein the process comprises the steps of: a) Preparing a graphene oxide solution; b) Mixing the graphene oxide solution with graphite flakes to receive a mixture; c) Heat treating the mixture of step b) in an increased temperature to remove water and oxygen from the mixture; and d) Compressing the heat treated mixture under pressure to obtain the block.

In one aspect of the invention the graphite block is formed of a mixture comprising 5-50% of graphene oxide and 50-95% of graphene flakes. In another aspect the mixture comprises the mixture comprises 90-95% of graphene flakes and 5-10% of graphene oxide, and in a still another aspect the mixture comprises 95% of graphene flakes and 5% of graphene oxide.

In one aspect of the invention the graphite block is formed of a mixture of graphene oxide and graphite flakes by heat treating the mixture in an elevated temperature and compressing the mixture under a high pressure.

It is accordingly an object of this invention to provide a composition for making graphite blocks of any size or shape with high carbon purity and high density.

It is another object of this invention to provide high purity graphite blocks with characteristics similar to natural graphite.

It is yet another object of this invention to provide an economic and environmentally clean method to make high purity graphite blocks with characteristics similar to natural graphite.

It is an object of this invention to provide high purity graphite blocks for use in furnace linings, lubrication, and electrodes.

It is an object of this invention to provide a graphite block originating from graphite flakes and graphene oxide, where the block has 99% carbon purity and a density higher than 1.8 g/cm³.

It is an object of this invention to provide a graphite block originating from graphite flakes and graphene oxide, where the block may be of any desired size and have the characteristics of natural graphite.

It is another object of this invention to provide a graphite block originating from graphite flakes and graphene oxide, where the block has a density substantially similar to natural graphite.

It is another object of this invention to provide a graphite block originating from graphite flakes and graphene oxide, where the block has superlubricating characteristics.

### BRIEF DESCRIPTION OF THE DRAWINGS

FIG. 1 shows a graphite blocks of this invention with dimensions of about 3″×4″×5″ (7.62×10.16×12.17 cm).

FIG. 2 shows the compressive testing apparatus for compressed graphite blocks.

FIGS. 3A, B, and C show failure modes of cylindrical blocks in compression tests. In FIG. 3A triplicate of blocks made under 3000 pressure are shown. In FIG. 3B triplicates of blocks made under 7500 psi pressure are shown. In FIG. 3C triplicates of blocks made under 10000 psi are shown.

FIG. 4 shows the modulus of rupture test set up for testing compressed graphite blocks.

FIG. 5 A, B, C show failure modes of cubical blocks in modulus rupture tests. In FIG. 5A triplicate of blocks made under 3000 pressure are shown. In FIG. 5B triplicates of blocks made under 7500 psi pressure are shown. In FIG. 5C triplicates of blocks made under 10000 psi are shown.

FIG. 6 shows stereoscopic photographs of the compressed graphite blocks compressed under 3000, 6500 or 10000 psi pressure. Top surface photographs as well as side surface photographs are shown. Two different magnifications are shown.

FIGS. 7A and B show HIROX micrographs of the compressed graphite blocks compressed under 3000, 6500 and 10,000 psi pressure. FIG. 7A shows the top surface micrographs and FIG. 7B shows the side surface micrographs. Three different magnifications are used.

### DETAILED DESCRIPTION OF THE INVENTION

### Definitions

By natural graphite it is meant graphite obtained from ore. Natural graphite may be flake graphite, amorphous graphite or vein graphite. The term natural graphite also includes graphite obtained from ore and purified chemically or thermally to increase the carbon purity.

By synthetic graphite it is meant graphite manufactured from coke and coal tar pitch. Also highly oriented pyrographite (HOPG) is included into the term synthetic graphite. Synthetic graphite also includes graphite made of polymer films.

By superlubricity it is meant a phenomenon where the friction nearly vanishes between two solid surfaces.

Graphene oxide is a compound of carbon, oxygen and hydrogen in variable rations. Traditionally graphene oxide is obtained by treating graphite with strong oxidizers. Maximally oxidized graphene is yellow solid with carbon: oxygen ratio between 2.1 and 2.0. By the oxidation of graphite using strong oxidizing agents, oxygenated functionalities are introduced in the graphite structure which not only expand the layer separation, but also makes the material hydrophilic (meaning that they can be dispersed in water). This property enables the graphite oxide to be exfoliated in water using sonication, ultimately producing single or few layer graphene, known as graphene oxide (GO). The main difference between graphite oxide and graphene oxide is, thus, the number of layers. While graphite oxide is a multilayer system, graphene oxide is few layered.

Graphene has been synthesized by many methods including mechanical exfoliation (Scotch tape method), chemical vapor deposition, epitaxial growth, and solution based approaches. Fabrication of large-area graphene has been the challenge and an average size of graphene sheets is 0.5-1 μm². International patent application publication WO2013/089642 for National University of Singapore which is incorporated herein by reference discloses a process for forming expanded hexagonal layered minerals and derivatives from graphite raw ore using electrochemical charging. Mesograf™ is large area few layered graphene sheets manufactured by the method disclosed in WO2013/089642. These few layered graphene sheets made in one step process from graphite ore have an area of 300-500 μm² in average.

Graphene oxide is a compound of carbon, oxygen and hydrogen in variable rations. Traditionally graphene oxide is obtained by treating graphite with strong oxidizers. Maximally oxidized graphene is yellow solid with carbon: oxygen ration between 2.1 and 2.0. Graphene oxide for use in this invention is preferably made from Mesograf™ instead of the process of oxidizing graphite first to graphite oxide and then via sonication to graphene oxide. Graphene oxide made of Mesograf™ is called Amphioxide™. Amphioxide™ is graphene oxidized at least 20%. Amphioxide™ retains the layer structure of Mesograf™.

Graphene oxide, including Amphioxide™ is highly hydrophilic. Amphioxide™ is the preferred graphene oxide of this disclosure and it is obtainable from Althean Limited, Guernsey. Amphioxide™ sheets have a lateral size of about 100 micrometers. The sheet may have lateral size as large as 200 micrometers. The area of Amphioxide™ sheets is at least 100 μm², and preferably at least 200 μm². The sheets may have an area as large as 300-500 μm².

Even if Amphioxide™ graphene oxide sheets is preferred in this invention, the graphene oxide may be of other sources as well.

Preferred embodiments of the invention are now described.

According to a preferred embodiment of this invention a mixture of graphite flakes of any size and a solution of graphene oxide sheets with area of at least 100 μm² is provided. According to a preferred embodiment the mixture contains 5-50 v-% of graphene oxide and 50-95 v-% of graphite flakes. The graphite flakes used may have coarse, fine or powder flake size. However, the flake size is not a determining factor of the process but any flake size can be used. The carbon purity of the flakes is preferably 87 to +99%, and more preferably 95 to +99% and most preferably +99%. The mixture is placed in an elevated temperature for a period of time that is required to removal of water and oxygen molecules of the graphene oxide component. Preferably the mixture is heat treated at 120-600° C., more preferably at 300-500° C., and most preferably at 300-400° C. Preferably the heat treatment is between 20 minutes to 3 hours, more preferably between 30 minutes to 2.5 hours, and most preferably from 60 minutes to 2 hours. After the heat treatment a pressure of at least 1,000 psi is applied on the mixture. There is no definite upper limit for the pressure to be used. According to one preferred embodiment the pressure may be up to 50,000 psi. Most preferably the pressure is between 3,000 and 10,000 psi. Once the pressure is released a block of graphite is received. The carbon grade of the block is higher than 99%, indicating that the heat treatment was efficient to remove water and oxygen from the mixture. Preferably the carbon grade is 99.0 to 99.9%. Most preferably the carbon grade is about 99.9%. The size of the block depends on the amount of the mixture used; there seems not to be any limit to the size of the block. The density and the strength of the block varies with the pressure used, but according to a preferred embodiment the density of the obtained block is about same as natural graphite.

According to a preferred embodiment the graphene oxide solution has 5 to 10 g/L of graphene oxide.

According to one preferred embodiment the graphene oxide is Amphioxide™.

According to another preferred embodiment the graphite block is enforced by mixing fibers, such as fiber glass fibers or basalt fibers into the mixture. According to a preferred embodiment the mixture has up to 12 v-% of fibers. The fibers may also include steel fibers, synthetic fibers and natural fibers.

The graphite block may also include fillers and extenders, such as but not limited to silica, kaolite, micas.

According to one preferred embodiment the resulting block is cubical. According to another preferred embodiment the resulting block is cylindrical. According to yet another embodiment the block may be of any feasible shape.

According to preferred embodiments the resulting graphite block is used to replace synthetic graphite in applications such as but not limited to electrodes, furnace linings, and lubrication.

The invention is now described in light of non-limiting examples. A skilled artisan understands that various changes and variations may be made to the examples without diverting from the spirit of this invention.

### Example 1

### A Method to Make a Graphite Block by Using 5% of 10 g//L Graphene Oxide and 95% of graphite flakes

A mixture containing 5 v-% of 10 g/L solution (in 3% HCl) of graphene oxide sheets with an average area of at least 100 μm² (Amphioxide™) and 95 v-% natural graphite flakes (Dixon #1 Flake Graphite) was prepared.

The mixture was heat treated in an oven in a temperature of 300° C. for 60 minutes.

Amphioxide is provided in water solution and Amphioxide includes approximately 20-30% oxygen. The heat treatment removes the water and the oxygen from the mixture. The heat treated mixture was compressed in a rectangular die at compaction force of 1000 ps. In this experiment the compaction force was applied for a period of 168 hours. Depending on the compaction force used and the size of the block, the time of compression may vary between 100 and 250 hours.

As a result of the treatment a graphite block was obtained. The carbon grade of the block was over 99% indicating that the heat treatment was sufficient to remove water and oxygen.

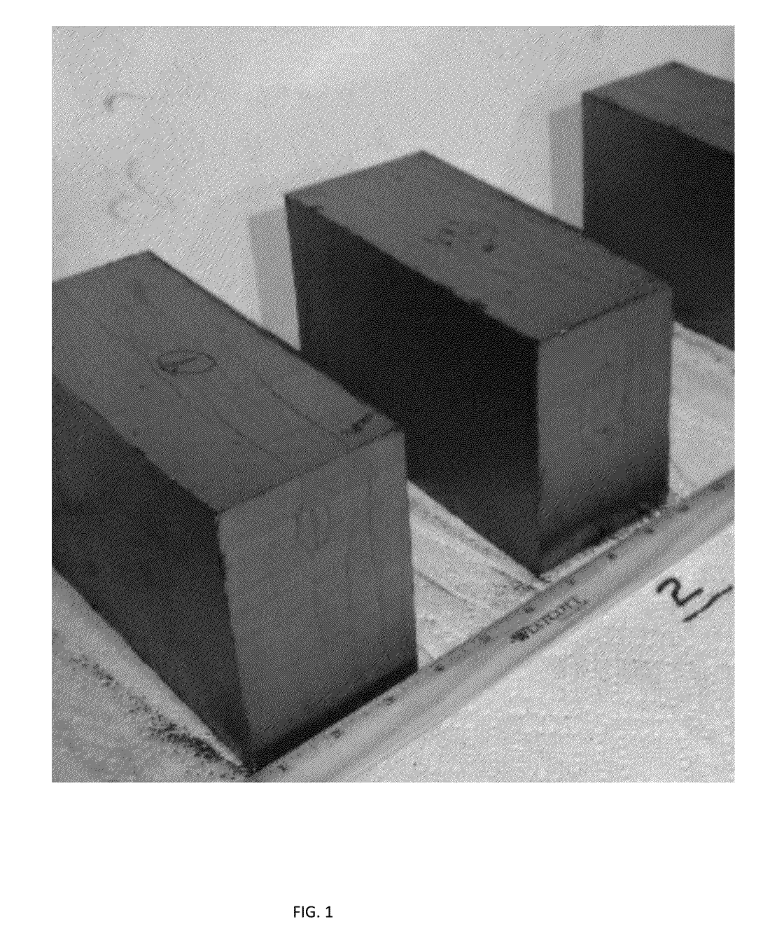

The carbon grade may be defined for example spectrophotometrically. The obtained block is shown in FIG. 1. In this case, the measurements of the block are 3″×4″×5″ (7.62×10.16×12.17 cm)

### Example 2

### A Method to Make a Graphite Block by Using 10% of 10 g//L Graphene and 90% of Graphite Flakes

A mixture containing 10 v-% of 10 g/L solution (in 3% HCl) of graphene oxide sheets with an average area of at least 100 μm² and 90% natural graphite flakes was prepared. The mixture was heat treated in an oven at a temperature of 400° C. for 120 minutes. The heat treated mixture was compressed in a rectangular die at compaction force of 1000 ps.

As a result of the treatment a graphite block is obtained. The carbon purity of the block is over 99%.

### Example 3

### A Method to Make a Graphite Block by Using 10% of 5 g//L Graphene and 90% of Graphite Flakes

A mixture containing 10 v-% of 5 g/L solution (3% HCl) of graphene oxide sheets with an area of at least 100 μm² (Amphioxide™) and 90% natural graphite flakes (Dixon #1 flake) was prepared. The mixture was heat treated in an oven at a temperature of 300° C. for 120 minutes. The heat treated mixture was compressed in a rectangular die at compaction force of 1000 ps.

As a result of the treatment a graphite block is obtained. The carbon purity of the block is over 99%.

### Example 4

### A Method to Make a Graphite Block by Using 50% of 10 g//L Graphene and 50% of Graphite Flakes

A mixture containing 50 v-% of 10 g/L solution (3% HCl) of graphene oxide sheets with average area of at least 100 μm² (Amphioxide™) and 50 v-% natural graphite flakes (Dixon #1 flake) was prepared. The mixture was heat treated in an oven at a temperature of 300° C. for 60 minutes. The heat treated mixture was compressed in a rectangular die at compaction force of 1000 ps.

As a result of the treatment a graphite block is obtained. The carbon purity of the block is over 99%.

### Example 5

### A Method to Make a Graphite Block by Using 10% of 10 g//L Graphene and 80% of Graphite Flakes and 10% of Fiber Glass

A mixture containing 10 v-% of 10 g/L solution (3% HCl) of graphene oxide sheets with average area at least 100 μm², 80% of natural graphite flakes and 10% of fiber glass fibers was prepared. The mixture was heat treated in an oven at a temperature of 300° C. for 120 minutes. The heat treated mixture was compressed in a rectangular die at compaction force of 1000 ps.

As a result of the treatment a graphite block is obtained.

### Example 6

### A Method to Make a Graphite Block by Using 10% of 10 g//L Graphene and 10% of Graphite Flakes and 10% of Basalt Fibers

A mixture containing 10 v-% of 10 g/L solution (in 3% HCl) of graphene oxide sheets with an area of at least 100 μm², 80 v % of natural graphite flakes and 10 v-% of basalt fibers was prepared. The mixture was heat treated in an oven at a temperature of 300° C. for 120 minutes. The heat treated mixture was compressed in a rectangular die at compaction force of 1000 ps.

As a result of the treatment a graphite block is obtained.

### Example 7

### Density Tests of Blocks Compressed Under Different Pressures

In this example a number of blocks were prepared by using various compaction forces to compress the blocks. The compression time was constant. A mixture containing 5 v-% of 10 g/L solution (in 3% HCl) of graphene oxide sheets with an average area of at least 100 μm² (Amphioxide™) and 95 v-% natural graphite flakes (Dixon #1 Flake Graphite) was prepared as described in Example 1. The mixture was heat treated for 120 minutes in 300° C. Samples of cubical and cylindrical blocks were made in a rectangular or a cylindrical die using compaction forces in pounds per square inch (psi) of 3,000, 5,000, 6,500, 7,500 and 10,000. The resulting blocks were weighted, and the density of the blocks was measured. Table 1 below shows the results with block type (B) and cylinder type (C) blocks.

TABLE 1

| Test | Block | Compression force | Weight | Pressed | Density |
|---|---|---|---|---|---|
| number | type | PSI × 1000 | (g) | volume (cc) | (g/cc) |
| 1 | B | 10.00 | 49.73 | 24.382 | 2.040 |
| 2 | B | 7.50 | 49.73 | 24.990 | 1.990 |
| 3 | C | 10.00 | 26.23 | 12.926 | 2.029 |
| 4 | C | 7.50 | 22.62 | 10.823 | 2.089 |

As is seen from Table 1, the density of the blocks is very high, ranging from 1.990 to 2.089 g/cc.

Table 2 below shows another set of tests. In this case only block type (B) blocks were tested.

TABLE 2

| Test | Block | Compression force | Weight | Pressure | Density |
|---|---|---|---|---|---|
| number | type | PSI × 1000 | (g) | volume ((cc) | (g/cc) |
| 1 | B | 3.00 | 34.09 | 18.190 | 1.874 |
| 2 | B | 3.00 | 37.42 | 30.975 | 1.784 |
| 3 | B | 3.00 | 35.65 | 19.664 | 1.813 |
| 4 | B | 6.50 | 34.34 | 17.206 | 1.996 |
| 5 | B | 6.50 | 37.84 | 19.173 | 1.973 |
| 6 | B | 6.50 | 35.73 | 18.190 | 1.964 |
| 7 | B | 10.00 | 35.56 | 17.534 | 2.028 |
| 8 | B | 10.00 | 37.71 | 18.517 | 2.036 |
| 9 | B | 10.00 | 29.95 | 15.076 | 1.987 |
| 10 | B | 10.00 | 35.49 | 17.534 | 2.024 |
| 11 | B | 10.00 | 36.83 | 17.543 | 2.100 |
| 12 | B | 10.00 | 36.10 | 17.698 | 2.040 |
| 14 | B | 7.50 | 36.15 | 18.190 | 1.987 |
| 14 | B | 5.00 | 36.07 | 18.517 | 1.948 |

Again it can be seen that the density of the blocks is very high, ranging from 1.784 g/cc in a block compressed under 3000 Psi to 2.2 g/cc in a block compressed under 10,000 Psi

Table 3 below shows the average densities of blocks compressed at a defined compression force level.

TABLE 3

| Compression force (PSI × 1000) | Average density (g/cc) |
|---|---|
| 10.00 | 2.043 |
| 7.50 | 2.002 |
| 6.50 | 1.978 |
| 5.00 | 1.948 |
| 3.00 | 1.824 |

The data in the Tables 1-3 indicate that the density of the samples is high and increases as the compaction force increase. The Dixon #1 Flake Graphite has a density of approximately 1.051 gram per cubic centimeter (g/cc). The data shows that the density increases from an average of 1.824 g/cc for the blocks compressed at 3,000 psi, to 1.984 g/cc for the blocks compressed at 5,000 psi, to 1.978 g/cc for the blocks compressed at 6,500 psi, to 2.002 g/cc for the blocks compressed at 7,500 psi and finally to 2.043 g/cc for the blocks compressed at 10,000 psi samples. The literature indicates that the natural density of graphite is approximately 2.2 g/cc. Theoretical density of graphite is 2.26 g/cc. Any value lower than this indicates that the graphite material is porous. Maximum values for nonimpregnated manufactured graphites is 1.90 g/cc. This means that in the very best case, about 16% of the volume of such bulk piece is open or closed pores. The blocks according to this invention compressed under 10,000 psi had an average density of 2.043 g/cc, which means that only about 1.1% of the block volume is open or closed pores. Accordingly, the blocks made with the method of this invention have very low porosity and a density very close to the theoretical density of natural graphite.

There is generally a correlation of hardness of graphite material to the density. As density increase, a general increase is seen in hardness. This is associated with the amount of porosity, which basically lowers the resistance to penetration. The lower the density, the greater the pore volume and the less the resistance to the penetrator, and hence, a lower hardness. Therefore, the high density of the blocks of this invention indicate low porosity as well as high hardness.

The density of graphite is also known to relate to electrical resistivity of graphite. As the density increases the electrical resistivity is known to decrease. Thus the high density of the blocks of this invention indicate lot resistivity or high conductivity, similar as natural graphite has. Furthermore, the density is known to relate to thermal conductivity of graphite. As the density increases, the thermal conductivity also increases. Upon higher thermal conductivity the material has higher thermal shock resistance.

### Example 7

### Compressive Strength Testing of the Compressed Graphite Blocks

Additional characterization data was developed on both cylinder- and block-type of blocks. The Table 4 below summarizes compressive strength testing performed on triplicate block samples. The blocks were made as described in Example 1 and compressed at pressures of 5000, 7500 and 10 000 psi.

The cylinder compression samples were made for compressive strength testing while the block samples were made for Modulus of Rupture testing. The average densities for both the cylinder and the block samples the three different compaction pressures are almost identical and mirror the densities shown in Tables 1-3.

When graphite material is portioned between two flat, parallel platens and a continually increasing compressive force is applied, the atomic or molecular bonds cannot be re-formed easily and therefore when crystalline planes begin to slip under the pressure, catastrophic failure occurs and the material fractures. The compressive strength of a brittle material such as graphite, is expressed as the maximum force per unit area that can be withstood before failure occurs.

TABLE 4
Characterization of cylinder (CL) and block (B) type of blocks.
Flake Graphite Compression Sample for Characterization Data

| | | | | | | | | Average | Modulus | Average |
|---|---|---|---|---|---|---|---|---|---|---|
| | Compression | | Pressed | | Average | Resistivity | Compressive | Compressive | of | Modulus |
| | Force | Weight | Volume | Density | Density | Ohms | Strength | Strength | Rupture | Rupture |
| Sample # | PSI × 1000 | (g) | (cc) | (g/cc) | (g/cc) | (Ω) | (psi) | (psi) | (ksi) | (ksi) |
| CL-1a | 5 | 29.75 | 15.32 | 1.94 | | 0.002 | 284 | | | |
| CL-1b | 5 | 29.7 | 15.55 | 1.91 | | 0.002 | 175 | | | |
| CL-1c | 5 | 29.67 | 15.58 | 1.90 | 1.919 | 0.002 | 463 | 308 | | |
| CL-2a | 7.5 | 29.91 | 14.81 | 2.02 | | 0.002 | 550 | | | |
| CL-2b | 7.5 | 29.8 | 14.95 | 1.99 | | 0.002 | 612 | | | |
| CL-2c | 7.5 | 29.77 | 14.94 | 1.99 | 2.002 | 0.002 | 464 | 542 | | |
| CL-3a | 10 | 29.84 | 14.55 | 2.05 | | 0.002 | 438 | | | |
| CL-3b | 10 | 29.81 | 14.62 | 2.04 | | 0.002 | 896 | | | |
| CL-3c | 10 | 29.77 | 14.64 | 2.03 | 2.042 | 0.002 | 786 | 706 | | |
| B-1a | 5 | 49.71 | 25.79 | 1.93 | | 0.002 | | | 65.9 | |
| B-1b | 5 | 49.7 | 25.84 | 1.92 | | 0.002 | | | 68.3 | |
| B-1c | 5 | 49.68 | 25.75 | 1.93 | 1.927 | 0.002 | | | 69.6 | 67.9 |
| B-2a | 7.5 | 49.7 | 24.97 | 1.99 | | 0.002 | | | 123.8 | |
| B-2b | 7.5 | 49.64 | 24.92 | 1.99 | | 0.002 | | | 114.1 | |
| B-2c | 7.5 | 49.65 | 24.93 | 1.99 | 1.991 | 0.002 | | | 121.3 | 119.7 |
| B-3a | 10 | 49.61 | 24.40 | 2.03 | | 0.002 | | | 143.9 | |
| B-3b | 10 | 49.61 | 24.37 | 2.04 | | 0.002 | | | 132.3 | |
| B-3c | 10 | 49.57 | 24.30 | 2.04 | 2.036 | 0.002 | | | 129.3 | 135.2 |

### Example 8

### Compression Tests with Cylindrical Blocks

Dixon #1 Flake Graphite was mixed with graphene oxide as described above in Example 1. After heat treating the mixture as described in example 1, samples were labeled as 1, 2 and 3 and the blocks were made in a cylindrical die and compacted at pressures of 5000, 7500 and 10000 psi, respectively. The compression tests were performed in triplicate and averages were calculated in pounds per square inch (psi). The results of the compression test are provided in Table 5 below.

TABLE 5
Compression strength tests for cylindrical blocks

| Specimen ID | Load (lb) | Compressive strength (psi) |
|---|---|---|
| 1A | 285 | 284 |
| 1B | 176 | 175 |
| 1C | 462 | 463 |
| Average | 308 | 308 |
| SD | 145 | 145 |
| CV % | 47 | 47 |
| 2A | 553 | 550 |
| 2B | 614 | 612 |
| 2C | 465 | 464 |
| Average | 544 | 542 |
| SD | 75 | 75 |
| CV % | 14 | 14 |
| 3A | 439 | 438 |
| 3B | 897 | 896 |
| 3C | 788 | 786 |
| Average | 708 | 706 |
| SD | 239 | 239 |
| CV % | 34 | 34 |

The test data indicates that the compressive strength increases from an average of 308 psi for the blocks compressed under 5,000 psi, to 542 psi for the blocks compressed under 7,500 psi and to 706 psi for the blocks compressed under 10,000 psi.

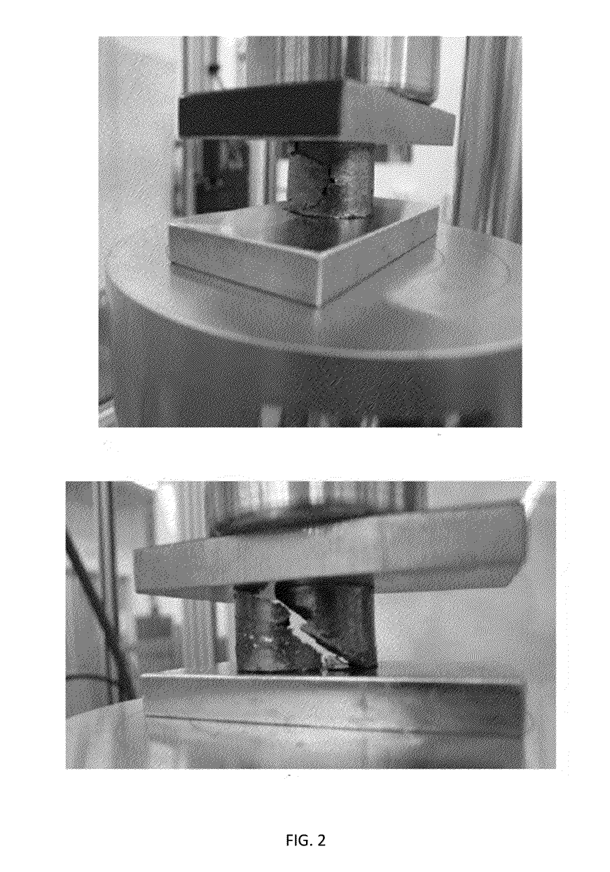

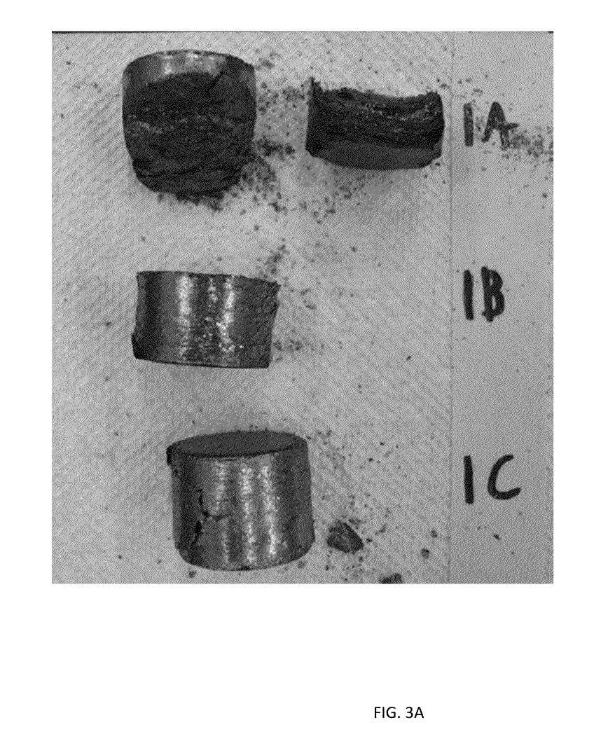

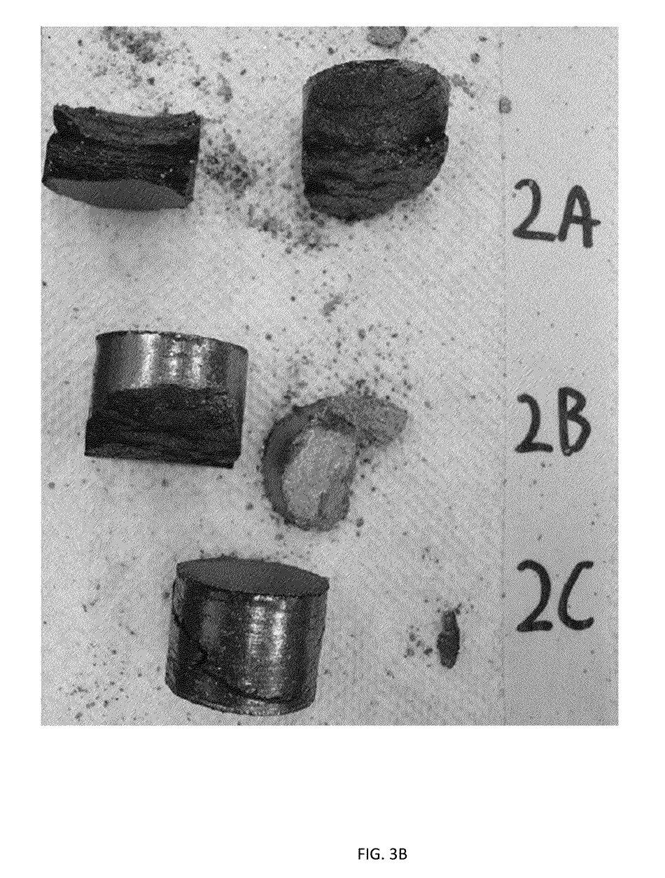

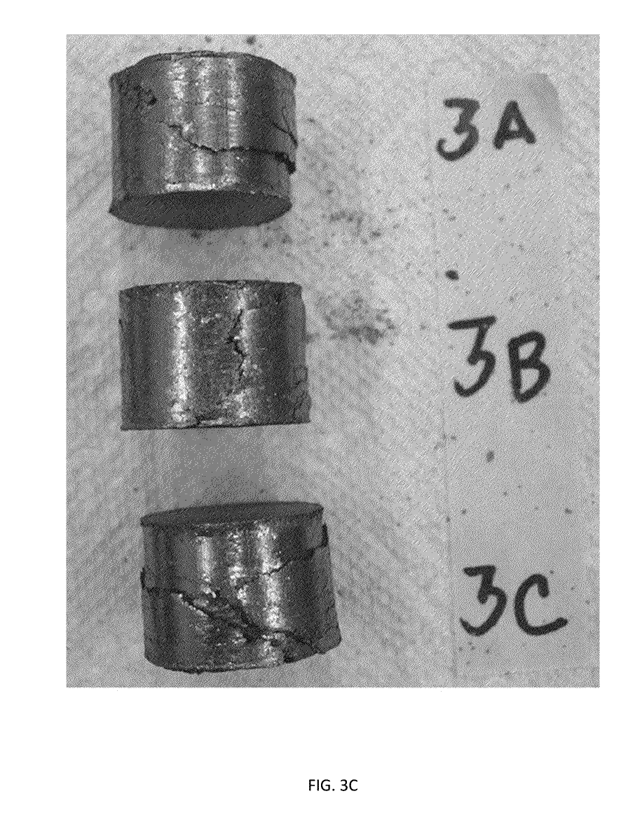

FIG. 2 shows the compressive testing apparatus. FIG. 3 shows failure modes of each tested triplicate.

### Example 9

### Modulus of Rupture Tests with the Cubical Blocks

Dixon #1 Flake Graphite was mixed with graphene oxide as described above in Example 1. After heat treating the mixture as described in example 1, the samples were labeled as 1, 2 and 3 and the blocks were made in a rectangular die and compacted at pressures of 5000, 7500 and 10000 psi, respectively. The modulus of rupture (MOR) tests were performed in triplicate and averages were calculated in pounds per square inch (psi). The results of the compression test are provided in Table 5 below.

TABLE 5
Modulus rupture date for cubic blocks

| Specimen ID | Width (in) | Thickness (in) | Load (lb) | MOR (ksi) |
|---|---|---|---|---|
| 1A | 0.638 | 0.959 | 12.5 | 65.9 |
| 1B | 0.638 | 0.957 | 12.9 | 68.3 |
| 1C | 0.638 | 0.955 | 13.1 | 69.6 |
| Average | | | 12.8 | 67.9 |
| SD | | | 0.3 | 1.9 |
| CV % | | | 2 | 3 |
| 2A | 0.638 | 0.924 | 21.8 | 123.8 |
| 2B | 0.638 | 0.924 | 20.1 | 114.1 |
| 2C | 0.638 | 0.925 | 21.4 | 121.3 |
| Average | | | 21.1 | 119.7 |
| SD | | | 0.9 | 5 |
| CV % | | | 4 | 4 |
| 3A | 0.638 | 0.903 | 24.2 | 143.9 |
| 3B | 0.638 | 0.906 | 22.4 | 132.3 |
| 3C | 0.638 | 0.902 | 21.7 | 129.3 |
| Average | | | 22.8 | 135.2 |
| SD | | | 1.3 | 7.7 |
| CV % | | | 6 | 6 |

The results indicate that the MOR increases from an average of 67.9 ksi for the blocks made under 5000 psi pressure, to 119.7 ksi for blocks made under 7500 psi pressure to 135.2 ksi for blocks made under 10 000 psi pressure.

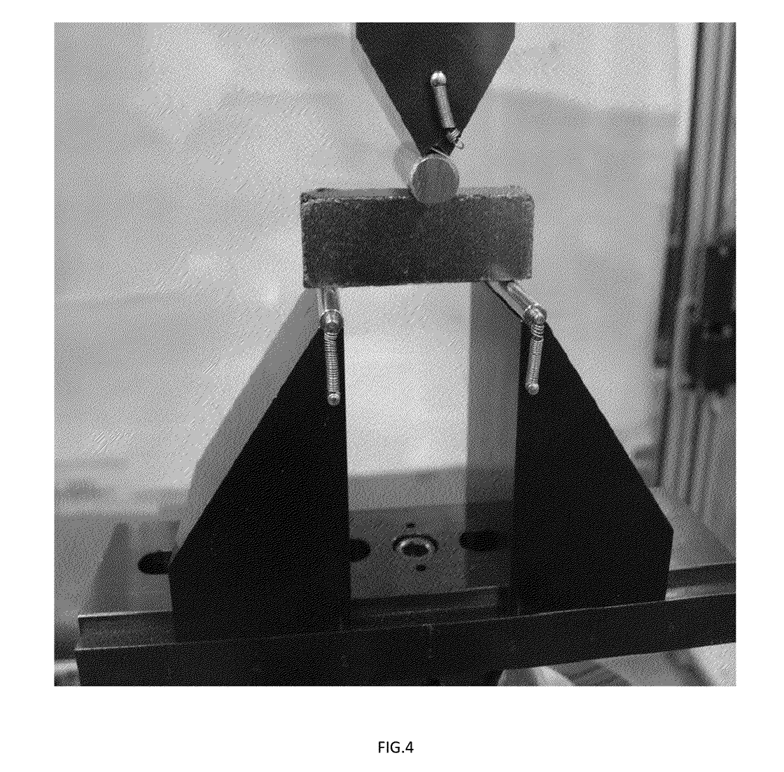

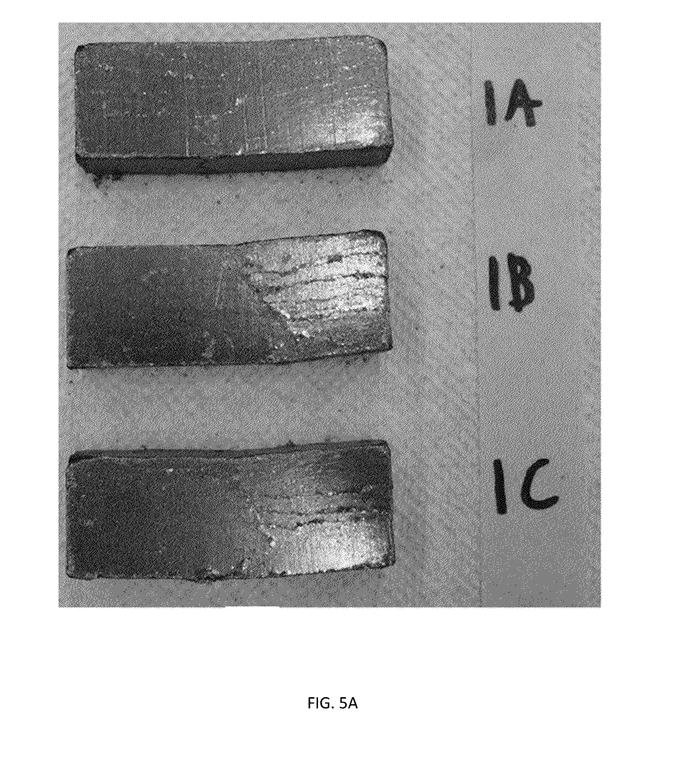

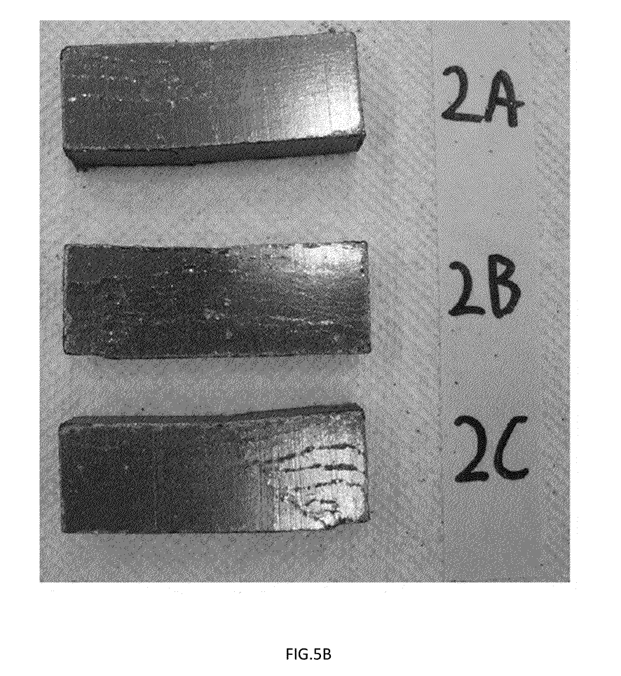

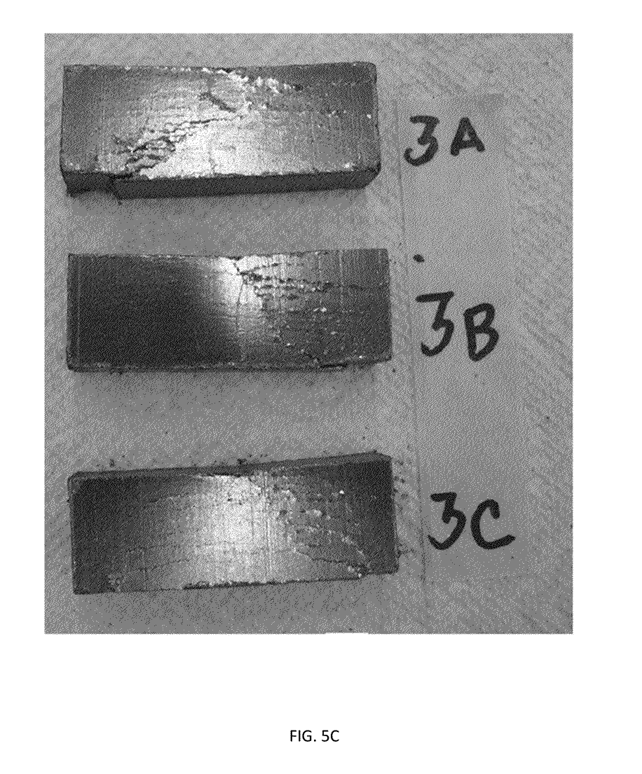

FIG. 4 shows the modulus of rupture test set up. FIG. 5 shows failure modes of each tested triplicate.

### Example 10

### Photographic Illustrations of the Dense Structure of the Blocks

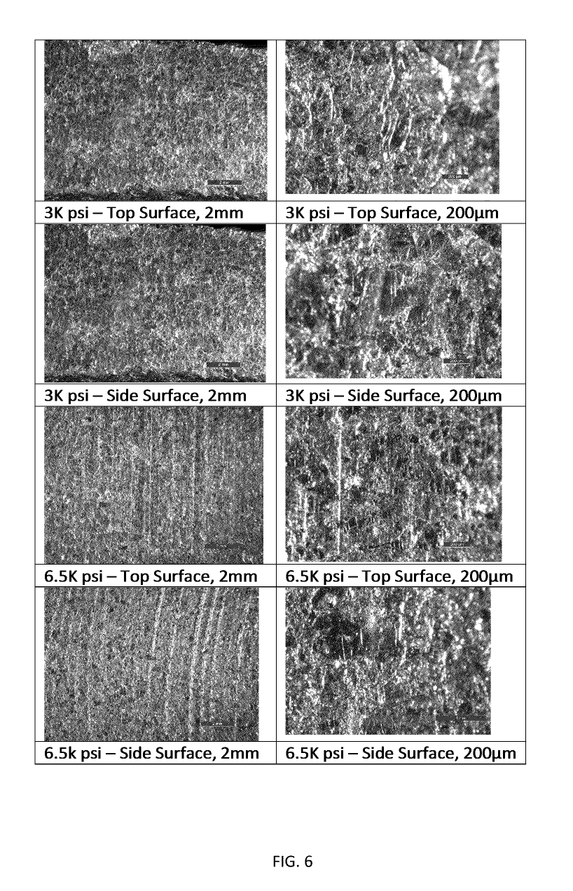

FIG. 6 shows stereoscopic photographs of the compressed graphite blocks compressed under 3000, 6500 or 10000 psi pressure. Top surface photographs as well as side surface photographs are shown. Two different magnifications are shown. The photographs reveal the increasing density of the material of blocks compressed under 3000, to blocks compressed under 6500 and to blocks compressed under 10000 psi.

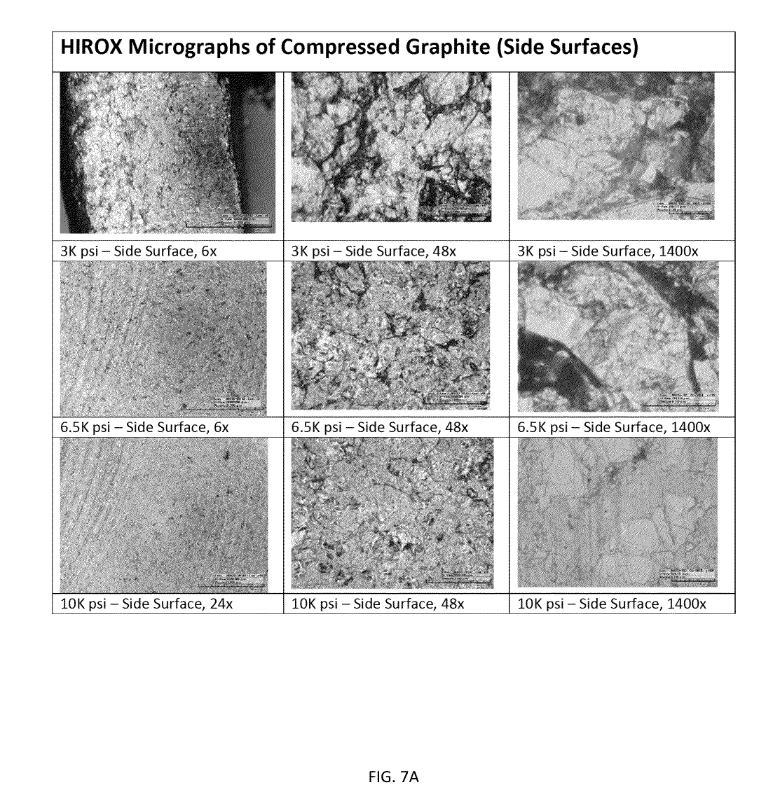

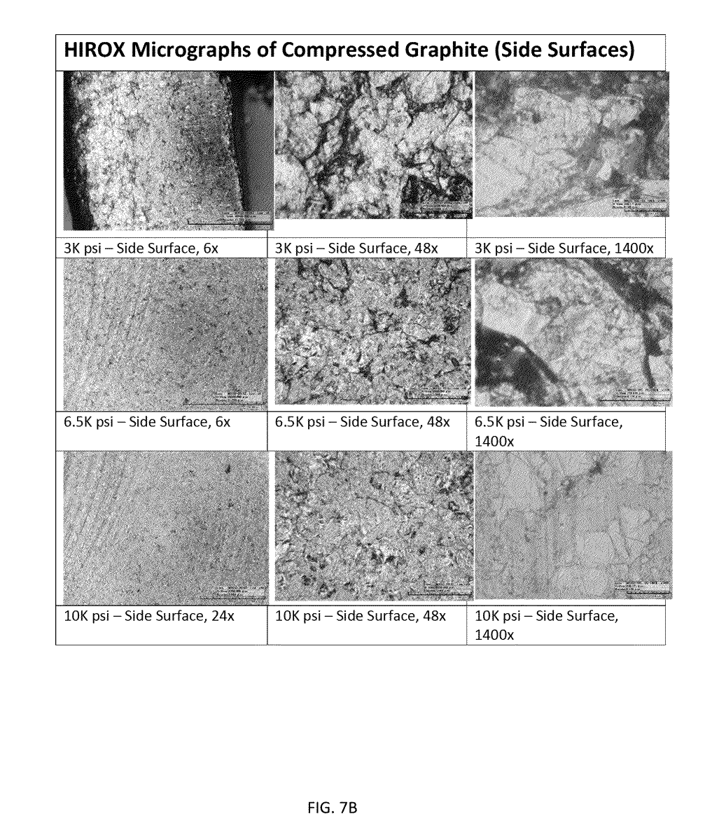

FIGS. 7A and B show HIROX micrographs of the compressed graphite blocks compressed under 3000, 6500 and 10 000 psi pressure. FIG. 7A shows the top surface micrographs and FIG. 7B shows the side surface micrographs. Three different magnifications are use. The photographs reveal the increasing density of the material of blocks compressed under 3000, to blocks compressed under 6500 and to blocks compressed under 10000 psi.

### Example 11

### Superlubricity Character of the Blocks

The lubrication characteristics of the blocks were confirmed by Atomic Force Microscopy. Preliminary results show that the when the block of this invention as prepared as described in Example 1 is rubbed on to a glass surface the lubrication effect is six times higher than for graphene (results not shown).

Graphite alone applied as a powder or as graphite foil showed 90% less lubrication than graphene. Moreover, graphite alone cannot be applied as a block or a brick as such structure does not exist.

When the block of this invention prepared as described in Example 1 was rubbed on SiO₂ the lubrication was 2 to 4 times more than rubbing graphene (results not shown). Again graphite powder or graphite foil alone did not show any improvement as compared to graphene's lubricating characters.

The great advantage of the present invention is that the superlubricator is provided in a form of a block. Therefore superlubrication becomes convenient as the block can simply be run across a surface that is in need of lubrication. This lubrication method can be used for example in making brakes, superlubricating rail guns and machine parts, wheels and so on.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A composition comprising graphite flakes and graphene oxide.

2. The composition of claim 1 comprising 1-10% of graphene oxide and 90-99% of graphite flakes.

3. The composition of claim 1, wherein carbon grade is over 90%.

4. The composition of claim 3, wherein carbon grade is 99%.

5. A graphite block composed of graphite flakes and graphene oxide.

6. The block of claim 5, wherein carbon grade is over 90%.

7. The block of claim 6, wherein carbon grade is 99%.

8. The block of claim 5, wherein the block has a density of at least 1.8 g/cm³.

9. The block of claim 8, wherein the density is at least 1.9 g/cm³.

10. The block of claim 9, wherein the density is at least 2.0 g/cm³.

11. The block of claim 5, wherein the block has a volume of at least 1 cm³.

12. The block of claim 11, wherein the block is cylindrical or cubical.

13. The block of claim 5, wherein the block has superlubricity character.

14. A reinforced graphite block composed of graphite flakes, graphene oxide and fiber glass or basalt fibers.

15. The block of claim 14, wherein the block is composed of 1-10% of graphene oxide, 80-99% of graphite flakes and 0-12% of the fibers.

16. A process to produce a graphite block from graphite flakes and graphene oxide, said method comprising the steps of:
a) Preparing a graphene oxide solution;
b) Mixing the graphene oxide solution with graphite flakes to receive a mixture;
c) Heat treating the mixture of step b) in an increased temperature to remove water and oxygen from the mixture; and
d) Compressing the heat treated mixture under pressure to obtain the block.

17. The process of claim 16, wherein the mixture of step b) comprises 5-50% of graphene oxide and 50-95% of graphene flakes.

18. The process of claim 17, wherein the mixture comprises 90-95% of graphene flakes and 5-10% of graphene oxide.

19. The process of claim 18, wherein the mixture comprises 95% of graphene flakes and 5% of graphene oxide.

20. The process of claim 19, wherein the graphene oxide is provided in a solution having 5-10 g graphene oxide in a liter.

21. The process of claim 16, wherein the increased temperature is 250 to 450° C.

22. The process of claim 16, wherein the mixture is heat treated for 60 to 120 minutes.

23. The process of claim 16, wherein compression in step d) is conducted under a pressure of 1,000 to 10,000 psi.

24. The process of claim 23, wherein compression is conducted under a pressure of 7,500 to 10,000 psi.

25. The process of claim 17, wherein the obtained block has a volume of at least 1 cm³.

26. The process of claim 24, wherein the obtained block has a density of at least 2.0 g/cm³.

27. The process of claim 17, wherein basalt or glass fibers are added to the mixture.
